(19) United States
(12) Patent Application Publication
(10) Pub. No.: US 2010/0019756 A1
(43) Pub. Date: Jan. 28, 2010

(54) DEVICE FOR MEASURING CELLULAR POTENTIAL, SUBSTRATE USED FOR THE SAME AND METHOD OF MANUFACTURING SUBSTRATE FOR DEVICE FOR MEASURING CELLULAR POTENTIAL

(75) Inventors: Soichiro Hiraoka, Osaka (JP); Masaya Nakatani, Hyogo (JP); Hiroshi Ushio, Hyogo (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/913,116

(22) PCT Filed: May 11, 2007
(86) PCT No.: PCT/JP2007/059743

§ 371 Date: Oct. 30, 2007

(30) Foreign Application Priority Data
May 17, 2006 (JP) 2006-137538

(51) Int. Cl. G01N 27/00; B32B 3/10; H01B 13/00

(52) U.S. Cl. 324/71.1; 428/131; 428/134; 216/17

(57) ABSTRACT

A device for measuring cellular potential includes a substrate, a first electrode tank, a first electrode, a second electrode tank and a second electrode. The first electrode tank and the second electrode tank are disposed on the upper side and lower side of the substrate, respectively. The first electrode is disposed inside the first electrode tank and the second electrode is disposed inside the second electrode tank. The substrate includes a single crystal plate having a diamond structure with (100) plane orientation or (110) plane orientation. The substrate has a first surface provided with a depression and a second surface facing this first surface. From the depression to the second surface, a through-hole is formed. The depression has an inner wall extending from the opening of the through-hole to the outer periphery, curving and being connected to the first surface.

This application is a U.S. National Phase application of PCT International Application PCT/JP2007/059743.

### TECHNICAL FIELD

The present invention relates to a device for measuring cellular potential, which is used for measuring an electrophysiological activity of cells, a substrate used for the same, and a method of manufacturing a substrate for a device for measuring cellular potential.

### BACKGROUND ART

A patch clamp technique is one of conventional methods for elucidating a function of an ion channel existing in a cell membrane or screening (examining) medicines with electrical activities of cells as a reference mark. In the patch clamp technique, a small portion (a patch) of the cell membrane is slightly sucked by a tip portion of a micropipette. Then, by using a fine electrode probe provided in the micropipette, electric current flowing across the patch in the fixed membrane potential is measured. Thus, opening and closing state of one or a few ion channels existing in the patch is electrically measured. This method is one of a few-number of methods capable of investigating a physiological function of a cell on real time basis.

However, the patch clamp technique requires a special technique and skill for preparation and operation of the micropipette, and much time is required to measure one sample. Therefore, this technique is not suitable for an application that requires high-speed screening of a large amount of candidate compounds for a medicine. On the other hand, recently, a flat-shaped fine electrode probe using a fine processing technology has been developed. Such a fine electrode probe is suitable for an automated system that does not require insertion of a micropipette for each individual cell. Hereinafter, the example thereof is described.

For example, patent document 1 discloses a technology for measuring potential-dependent ion channel activities of a test cell attached to an opening of a through-hole by an electrode disposed on the lower side of a plurality of through-holes provided in a cell holding substrate. Furthermore, recently, there has been disclosed a technology for measuring extracellular potential with high degree of accuracy by forming a through-hole of 2.5 μm inside a cell holding substrate made of silicon oxide and allowing this through-hole to hold HEK293 cell which is a kind of human cultured cell line, so as to secure high adhesiveness.

Patent document 2 discloses device 1 for measuring cellular potential shown in FIG. 27. Device 1 for measuring cellular potential includes substrate 2 and well 3 disposed on the upper side of substrate 2. On the upper surface of substrate 2, depression 4 is formed. Through-hole 5 penetrating from the lower part of depression 4 to the lower surface of substrate 2 is provided. In well 3, first electrode 6 is disposed. In through-hole 5, second electrode 7 is disposed. Furthermore, second electrode 7 is connected to a signal detector via wiring 8.

Next, an operating method of device 1 for measuring cellular potential is described. Firstly, test cell (hereinafter, referred to as “cell”) 10 and electrolyte 9 are filled in well 3. Cell 10 is captured and held by depression 4. When measurement is carried out, cell 10 is sucked with a suction pump or the like from the lower side of through-hole 5 and held in a state in close contact with an opening of through-hole 5. That is to say, through-hole 5 plays the same role as a tip hole of a glass pipette. The function, pharmacological reaction, or the like of the ion channel of cell 10 can be analyzed by measuring voltage or current between first electrode 6 and second electrode 7 before and after the reaction so as to calculate the potential difference between the inside and outside of cell 10. As mentioned above, by providing depression 4, even when thick substrate 2 is used for securing mechanical strength, the length of through-hole 5 is reduced, and the processing becomes easier. Furthermore, suction force to cell 10 from the lower side of substrate 2 is increased.

However, in a conventional technology using dry etching or the like, while depression 4 and through-hole 5 are processed in substrate 2, it is not possible to understand how far the process is progressed. Consequently, it is not possible to control depth of depression 4 and through-hole 5 with high degree of accuracy. As a result, length of through-hole 5 tends to vary, so that it may be impossible to bring cell 10 into close contact with through-hole 5 appropriately. When cell 10 is sucked, pressure applied to cell 10 becomes short depending upon the length of through-hole 5. As a result, cell 10 may be damaged or the adhesiveness (seal resistance) between cell 10 and through-hole 5 may be reduced. Thus, the measurement accuracy of device 1 for measuring cellular potential may be reduced.

Furthermore, when depression 4 is formed, surface roughness of the inner wall of depression 4, in particular, the peripheral portion of through-hole 5 is increased. This phenomenon is particularly remarkable when through-hole 5 is formed by providing a resist mask having a mask hole of an opening diameter of 3 μm or less on the upper surface of substrate 2 for forming through-hole 5 and by performing dry etching substrate 2 via this resist mask. Furthermore, when depression 4 is formed, the etching speed in a horizontal direction is higher than the etching speed in a depth direction, and level difference is formed in the middle of depression 4. Thus, the symmetry of depression 4 is low.

The cause of them has not been clarified. However, for example, it is thought to be partly because when an etching gas is filled in depression 4 through a fine mask hole, the etching gas is not dispersed uniformly. Thus, the surface roughness of depression 4 is large and the symmetry of the shape is low. Partly because of this, the adhesiveness (seal resistance) between cell 10 and through-hole 5 is lowered. Consequently, the measurement accuracy of device 1 for measuring cellular potential is lowered.

[Patent Document 1] Japanese Translation of PCT Publication NO. 2002-518678

[Patent Document 2] Published PCT International Applications No. 02/055653 pamphlet

### SUMMARY OF THE INVENTION

The present invention relates to a device for measuring cellular potential in which variation of depths of through-holes is reduced and the measurement accuracy is improved, a substrate used for the same, and a method of manufacturing a substrate for a device for measuring cellular potential. The device for measuring cellular potential of the present invention includes a substrate, a first electrode tank, a first electrode, a second electrode tank, and a second electrode. The first electrode tank is disposed on the upper side of the substrate and the second electrode tank is disposed on the lower side of the substrate, respectively. The first electrode is disposed in the first electrode tank and the second electrode is disposed in the second electrode tank, respectively. The substrate is formed of a single crystal plate having a diamond structure with (100) plane orientation or (110) plane orientation. The substrate has a first surface provided with a depression and a second surface facing the first surface. Furthermore, a through hole is provided from the depression to the second surface. The depression has an inner wall extending from an opening of the through-hole to an outer periphery, curving, and connected to the first surface.

Such a substrate is produced as follows. On the first surface of the above-mentioned single crystal plate material, a resist mask having a mask hole is formed by using a photo-mask. The first surface is provided with a depression by dry etching. Then, a through-hole having the same opening diameter as that of the mask hole is provided by allowing the through-hole to penetrate the substrate from the depression to the second surface by dry etching. Thus, it is possible to reduce variation in length of the though-hole and to enhance the measurement accuracy of the device for measuring cellular potential.

### BRIEF DESCRIPTION OF THE DRAWINGS

FIG. 1 is a sectional view showing a device for measuring cellular potential in accordance with a first exemplary embodiment of the present invention.

FIG. 2 is a perspective view showing a chip in the device for measuring cellular potential shown in FIG. 1.

FIG. 3 is a sectional view showing the chip shown in FIG. 2.

FIG. 4 is an enlarged sectional view showing the chip shown in FIG. 3.

FIG. 5 is a sectional view showing a step of manufacturing the chip shown in FIG. 2.

FIG. 6 is a sectional view showing a step of manufacturing the chip shown in FIG. 2, following the step shown in FIG. 5.

FIG. 7 is a sectional view showing a step of manufacturing the chip shown in FIG. 2, following the step shown in FIG. 6.

FIG. 8 is a sectional view showing a step of manufacturing the chip shown in FIG. 2, following the step shown in FIG. 7.

FIG. 9 is a sectional view showing a step of manufacturing the chip shown in FIG. 2, following the step shown in FIG. 8.

FIG. 10A is a view showing a scanning electron microscope image of the device for measuring cellular potential shown in FIG. 1.

FIG. 10B is a schematic view showing the scanning electron microscope image shown in FIG. 10A.

FIG. 11 is a schematic view showing a position of (111) plane orientation in a single crystal silicon plate of (100) plane orientation, which is a substrate of the device for measuring cellular potential, in accordance with the first exemplary embodiment of the present invention.

FIG. 12 is a perspective view showing a chip in a device for measuring cellular potential in accordance with a second exemplary embodiment of the present invention.

FIG. 13 is a sectional view showing the chip shown in FIG. 12.

FIG. 14 is a schematic view showing a position of (111) plane orientation in a single crystal silicon plate of (110) plane orientation, which is a substrate of the device for measuring cellular potential, in accordance with the second exemplary embodiment of the present invention.

FIG. 15 is a sectional view showing a chip in a device for measuring cellular potential in accordance with a third exemplary embodiment of the present invention.

FIG. 16 is a sectional view showing a step of manufacturing the chip shown in FIG. 15.

FIG. 17 is a sectional view showing a step of manufacturing the chip shown in FIG. 15, following the step shown in FIG. 16.

FIG. 18 is a sectional view showing a step of manufacturing the chip shown in FIG. 15, following the step shown in FIG. 17.

FIG. 19 is a sectional view showing a step of manufacturing the chip shown in FIG. 15, following the step shown in FIG. 18.

FIG. 20 is a sectional view showing a step of manufacturing the chip shown in FIG. 15, following the step shown in FIG. 19.

FIG. 21 is a sectional view showing a step of manufacturing the chip shown in FIG. 15, following the step shown in FIG. 20.

FIG. 22 is a sectional view showing a chip in a device for measuring cellular potential in accordance with a fourth exemplary embodiment of the present invention.

FIG. 23 is a sectional view showing a chip in a device for measuring cellular potential in accordance with a fifth exemplary embodiment of the present invention.

FIG. 24 is an enlarged sectional view showing the chip shown in FIG. 23.

FIG. 25 is a sectional view showing a chip in a device for measuring cellular potential in accordance with a sixth exemplary embodiment of the present invention.

FIG. 26 is an enlarged sectional view showing the chip shown in FIG. 25.

FIG. 27 is a sectional view showing a conventional device for measuring cellular potential.

### DETAILED DESCRIPTION OF THE PREFERRED EMBODIMENTS

Hereinafter, exemplary embodiments of the present invention are described with reference to drawings. In each exemplary embodiment, the same reference numerals are given to the same configurations as those of the preceding exemplary embodiments, and detailed description therefor may be omitted. Furthermore, the present invention is not limited to each exemplary embodiment.

### First Exemplary Embodiment

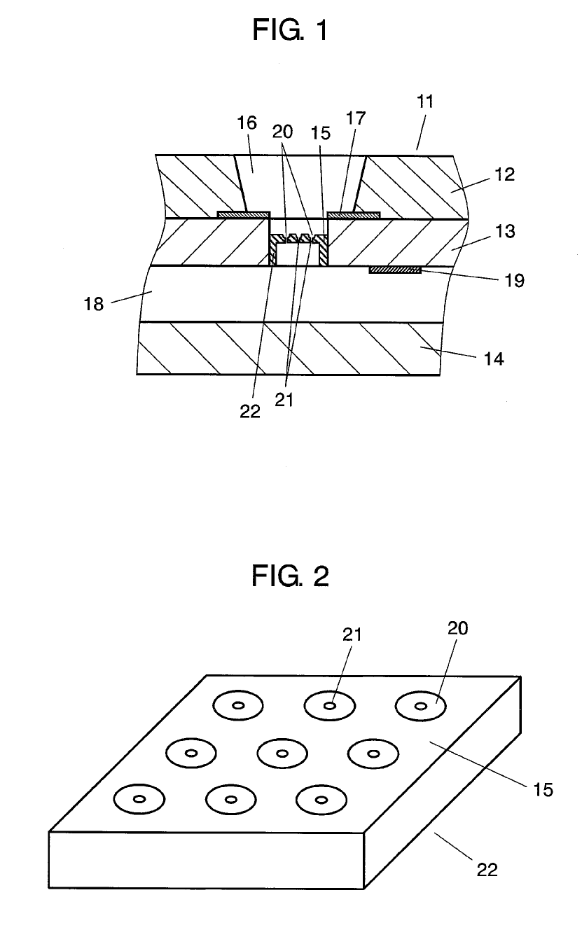

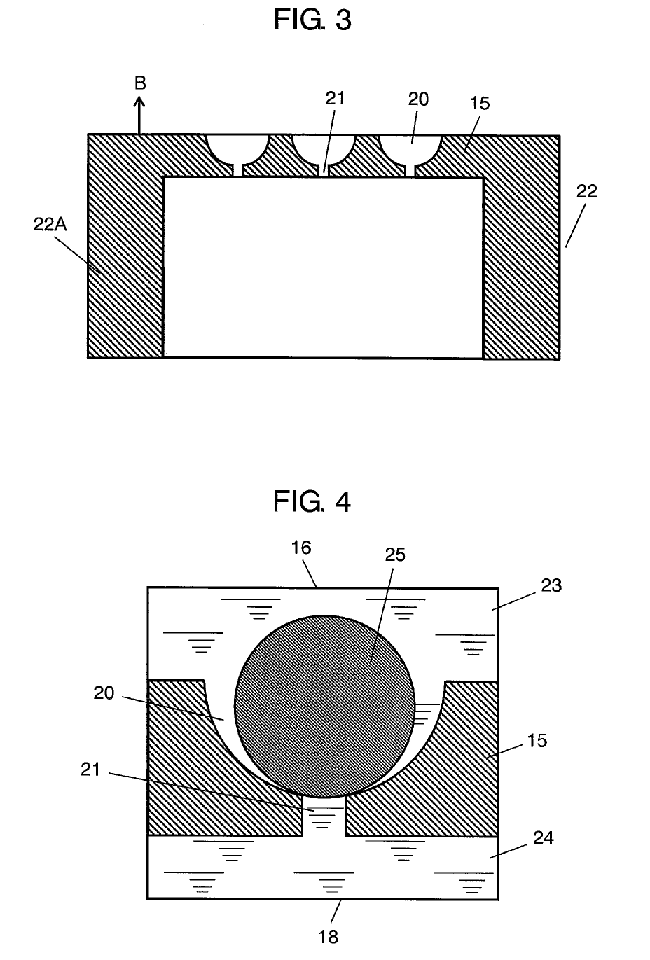

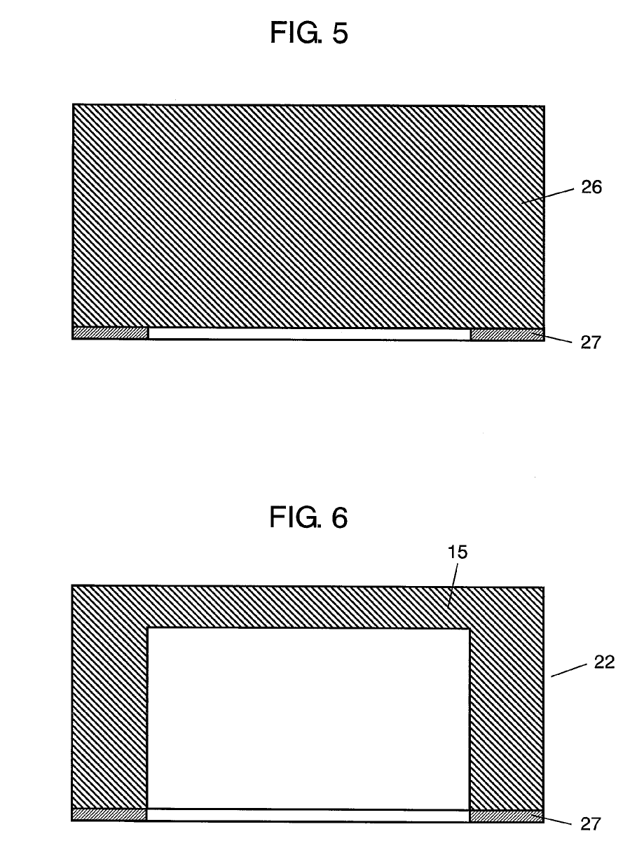

FIG. 1 is a sectional view showing a device for measuring cellular potential in accordance with a first exemplary embodiment of the present invention. FIG. 2 is a perspective view showing a chip in the device for measuring cellular potential shown in FIG. 1. FIG. 3 is a sectional view showing the chip shown in FIG. 2. FIG. 4 is an enlarged sectional view showing the chip shown in FIG. 3. Device 11 for measuring cellular potential includes well plate 12, chip plate 13 disposed on the lower surface of well plate 12, and flow passage plate 14 disposed on the lower surface of chip plate 13.

Into an opening of chip plate 13, chip 22 having substrate 15 and side wall 22A standing from the lower surface of substrate 15 is inserted. On the upper side of substrate 15, first electrode tank 16 is provided. Inside first electrode tank 16 and on the upper surface of chip plate 13, first electrode 17 is disposed. Furthermore, on the lower side of chip plate 13 and between chip plate 13 and flow passage plate 14, second electrode tank 18 is provided. Inside second electrode tank 18 and on the lower surface of chip plate 13, second electrode 19 is disposed.

As shown in FIGS. 2 and 3, on an upper surface (first surface) of substrate 15, depression 20 is formed. From the deepest portion of depression 20 to a lower surface (second surface) of substrate 15, through-hole 21 is formed vertically. In other words, substrate 15 includes a first surface and a second surface facing the first surface. On the first surface, depression 20 is formed. From depression 20 to the second surface, through-hole 21 is formed.

Depression 20 is formed in a substantially hemispherical shape that has an inner wall extending from the center of the opening of through-hole 21 to the outer periphery, smoothly curving and standing upwardly. The surface roughness of the inner wall of through-hole 21 is larger than the surface roughness of the inner wall of depression 20.

Substrate 15 is a silicon single crystal plate having a diamond structure with plane orientation of (100). Arrow B in FIG. 3 shows a normal vector of (100) plane orientation. The thickness of substrate 15 is about 20 μm. The (100) plane orientation includes (010) plane orientation and (001) plane orientation, which are equivalent by symmetry of the crystalline structure.

The diameter of the opening of depression 20 is about 30 μm and the minimum opening diameter of through-hole 21 is 3 μm. Since depression 20 has a substantially hemispherical shape, the depth of depression 20 is about 15 μm and the length of through-hole 21 is about 5 μm.

The minimum opening diameter of through-hole 21 and the diameter of the opening of depression 20 are determined depending upon the size, shape, and nature of cell 25 to be tested. When the size of cell 25 is about 5 to 50 μm, for maintaining high adhesiveness between cell 25 and through-hole 21, it is desirable that the minimum opening diameter of through-hole 21 is made to be more than 0 μm and not more than 3 μm. When it is difficult to suck first electrolyte 23, it is preferable that the minimum opening diameter is made to be 0.1 μm or more. It is advantageous because the fluidity is improved. Furthermore, the length of through-hole 21 is set depending upon the pressure at the time of sucking in order to appropriately suck cell 25 into through-hole 21 as mentioned below. In this exemplary embodiment, the length of through-hole 21 is set in the range from about 2 μm to 10 μm.

Next, the operation of device 11 for measuring cellular potential is described. As shown in FIG. 4, firstly, first electrode tank 16 is filled with cell 25 and first electrolyte 23, and second electrode tank 18 is filled with second electrolyte 24.

Then, by depressurizing the lower side of substrate 15 or pressurizing the upper side thereof, cell 25 and first electrolyte 23 are attracted to through-hole 21. At this time, cell 25 is captured by depression 20 and held so as to block the opening of through-hole 21. Thereafter, while cell 25 is held by depression 20 by depressurizing or pressurizing, cells that are not held are removed by washing with physiological saline.

When cell 25 is a mammalian muscle cell, as first electrolyte 23, for example, aqueous solution including 155 mM (mmol/dm³) potassium ion (K⁺), 12 mM sodium ion (Na⁺) and 4.2 mM chlorine ion (Cl⁻) is used. As second electrolyte 24, aqueous solution including 4 mM K⁺, 145 mM Na⁺, and 123 mM Cl⁻ is used. First electrolyte 23 and second electrolyte 24 may have different compositions as in this exemplary embodiment or they may be the same.

Next, by sucking from the lower side of substrate 15 or by infusing medicine such as nystatin from the lower side of substrate 15, a fine hole is formed in cell 25. Thereafter, chemical stimulation or physical stimulation is given to cell 25. The chemical stimulation may include, for example, a chemical medicament or poison. The physical stimulation may include, for example, mechanical displacement, light, heat, electricity, electromagnetic wave, or the like. When cell 25 reacts actively against such stimulation, for example, cell 25 discharges or absorbs various types of ions through an ion channel which the cell membrane possesses. Then, ion current running in cell 25 occurs and the potential gradient inside and outside of cell 25 is changed. This change is detected by measuring a voltage or a current between first electrode 17 and second electrode 19 before and after the reaction.

Next, the invention relating to a method of manufacturing device 11 for measuring cellular potential in accordance with the exemplary embodiments of the present invention is described with reference to FIGS. 5 to 9. FIGS. 5 to 9 are sectional views showing steps of manufacturing the chip shown in FIG. 2, respectively.

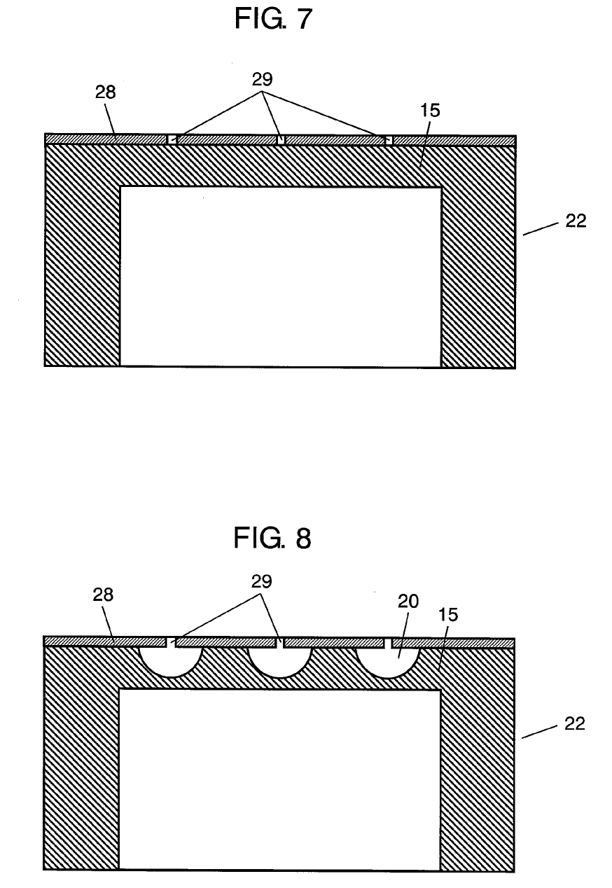

Firstly, as shown in FIG. 5, on the lower surface of chip substrate 26 made of a single crystal silicon plate material with (100) plane orientation, resist mask 27 is formed. Next, as shown in FIG. 6, etching is carried out to a predetermined depth from the lower surface of chip substrate 26. Chip 22 having substrate 15 is formed on the upper surface thereof. Thereafter, resist mask 27 is removed.

Next, as shown in FIG. 7, on the upper surface (first surface) of substrate 15, resist mask 28 is formed. At this time, the shape of mask hole 29 of resist mask 28 is designed so as to be substantially the same as that of the opening of through-hole 21 shown in FIG. 3. In this exemplary embodiment, since the minimum diameter of through-hole 21 is 3 μm, the opening diameter of mask hole 29 is also 3 μm. Furthermore, it is preferable that resist mask 28 is formed of a material that is not easily etched so that the shape of mask hole 29 is not changed. Specifically, it is desirable to use silicon oxide, silicon nitride, silicon oxynitride, or the mixture thereof.

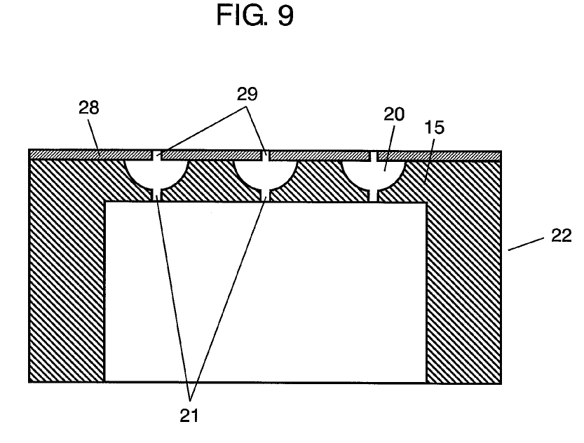

Thereafter, as shown in FIG. 8, depression 20 is formed on the upper surface of substrate 15 by dry etching. When substrate 15 is silicon, as an etching gas for promoting etching, SF₆, CF₄, NF₃, or XeF₂ or the mixed gas of two or more of them can be used. Since these have an effect of promoting etching not only in the depth direction of silicon but also in the horizontal direction of silicon, substrate 15 is etched in a shape of a hemispherical bowl.

Next, as shown in FIG. 9, in a state in which resist mask 28 is disposed, through-hole 21 penetrating in the vertical direction from the deepest portion of depression 20 to the lower surface (second surface) of substrate 15 is formed. When through-hole 21 is formed, dry etching processing is carried out by using the above-mentioned etching gas (at least one of SF₆, CF₄, NF₃, and XeF₂) for promoting etching and a gas for suppressing the etching alternately. As the gas for suppressing etching, CHF₃, C₄F₈, or a mixed gas thereof can be used. When such a gas is blown to the etched wall surface, a protective film that is polymer of CF₂ is formed. Therefore, through-hole 21 can be allowed to proceed from the deepest portion of depression 20 to the lower surface of substrate 15.

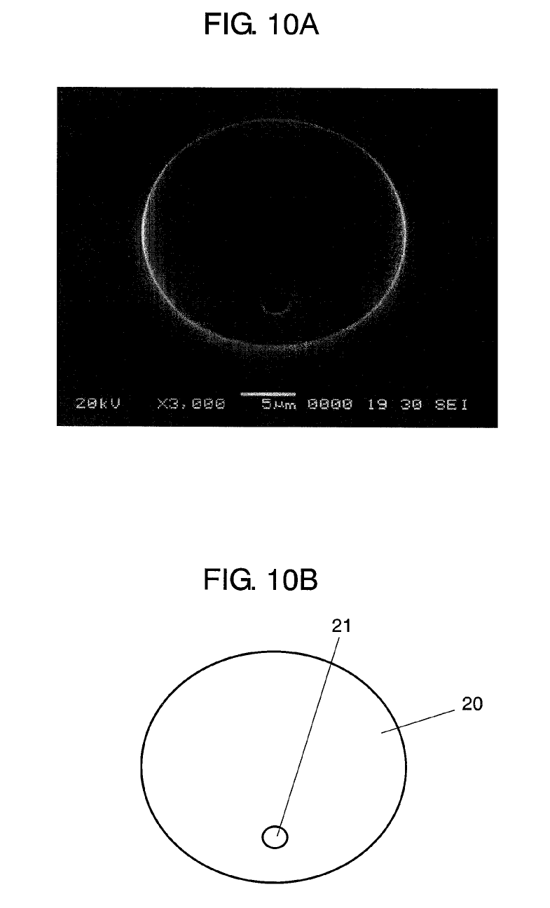

As mentioned above, when resist mask 28 is removed after through-hole 21 is formed, substrate 15 provided with depression 20 and through-hole 21 is completed as shown in the scanning electron microscope image of FIG. 10A and the schematic view of FIG. 10B. Note here that FIG. 10A shows an observation result shown from the angle of 30° with respect to the surface of substrate 15.

Note here that by carrying out an etching process as mentioned above in a state in which substrate 15 is inclined obliquely, through-hole 21 may be formed on the lower surface of substrate 15 not only perpendicularly but also obliquely.

As mentioned above, after through-hole 21 is formed, as shown in FIG. 1, first electrode 17 is formed on the upper surface of chip plate 13 and second electrode 19 is patterned on the lower surface thereof by metal deposition, electroless plating, or the like. First electrode 17 and second electrode 19 may be formed for each chip 22 or may be shared by a plurality of chips 22.

Next, well plate 12 is attached to the upper surface of chip plate 13 by using an adhesive agent, and chip 22 is mounted on the opening of chip plate 13. Then, flow passage plate 14 is attached to the lower surface of chip plate 13. Thus, first electrode tank 16 is disposed on the upper side of substrate 15, and second electrode tank 18 is disposed on the lower side of substrate 15, respectively. Device 11 for measuring cellular potential is completed.

In this exemplary embodiment, as shown in FIG. 10A, a silicon single crystal plate having a diamond structure with (100) plane orientation is used as substrate 15. Therefore, even if depression 20 is formed by dry etching, concavity and convexity on the surface of depression 20 are reduced, so that etching proceeds uniformly. As a result, formed depression 20 has a shape that is excellent in symmetry with respect to opening of through-hole 21 as the center. Thus, the depth of depression 20 can be easily calculated from the opening diameter of depression 20 that can be measured from the outer appearance. Then, from the depth of depression 20 and thickness of substrate 15, the length of through-hole 21 can be calculated. As a result, variation in the length of through-hole 21 is reduced, so that the measurement accuracy of device 11 for measuring cellular potential can be improved.

Furthermore, as mentioned above, the surface roughness of the inner wall of depression 20 is reduced. Therefore, by capturing cell 25 by smooth depression 20, the adhesiveness (seal resistance) between through-hole 21 and cell 25 can be enhanced. As a result, the measurement accuracy of device 11 for measuring cellular potential can be improved.

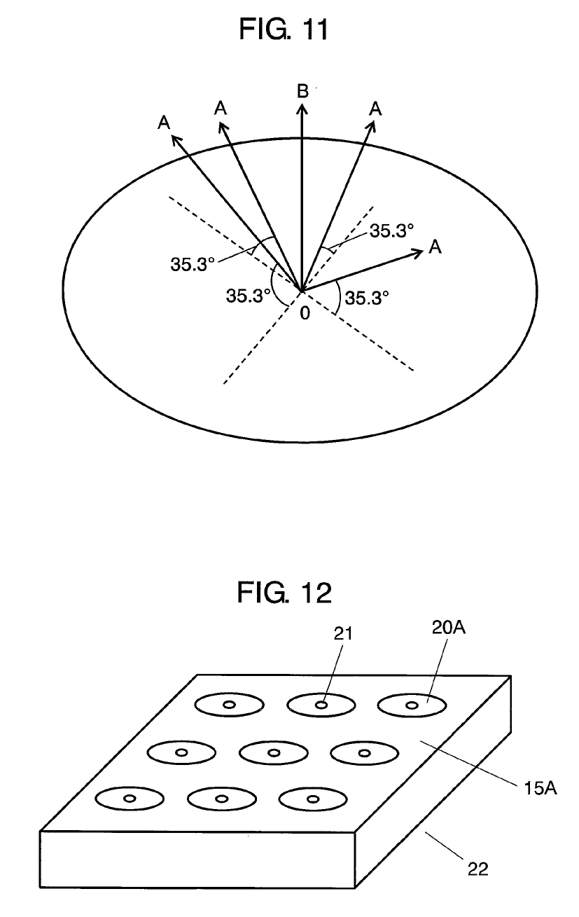

Herein, the reason why the surface roughness of the inner wall of depression 20 can be reduced is described with reference to FIG. 11. FIG. 11 is a schematic view showing substrate 15 made of a single crystal silicon plate with (100) plane orientation used in this exemplary embodiment. Vector A shows a normal vector of (111) plane orientation of substrate 15 with (100) plane orientation. Vector B is a normal vector of (100) plane orientation.

Vector A declines at 35.3° with respect to the upper surface of substrate 15 and has (111) plane orientation at 54.7° with respect to the upper surface of substrate 15. Substrate 15 has such vectors A at equal positions in a concentric hemispherical shape with respect to center O.

Silicon forming substrate 15 has a diamond crystalline structure in which all silicon atoms are bonded to each other with four binding members. Then, in this (111) plane orientation, the density of silicon atoms is maximum. Three of the binding members of silicon extend from the surface of substrate 15 to the lower part, and only one binding member is free and present on the surface layer. On the other hand, in (100) plane orientation, two free binding members are present in a way in which they protrude from the surface of substrate 15 and show a high reactivity. Therefore, the etching in the direction of normal vector B of (100) plane orientation is much faster than that of the etching in the direction of normal vector A of (111) plane orientation.

That it so say, in silicon substrate 15 with (100) plane orientation used in this exemplary embodiment, since the etching in the direction of vector B is fast, the etching in the depth direction of depression 20 is promoted. Furthermore, since vectors A are present equally in the radial direction, the etching easily proceeds symmetrically. Thus, it is thought that the surface roughness of the inner wall of depression 20 can be reduced. As a result, the shape of depression 20 has a hemispherical shape that is excellent in symmetry.

The etching conditions such as etching processing time and the like can be easily adjusted while confirming the appearance of depression 20 by using an optical microscope or the like. Thus, the manufacturing process can be facilitated. Then, it is possible to set the length of through-hole 21 with high degree of accuracy from the depth of depression 20 and the thickness of substrate 15. Furthermore, since the surface of depression 20 becomes smooth, the adhesiveness between cell 25 and through-hole 21 is enhanced and the measurement accuracy of device 11 for measuring cellular potential is improved.

As the etching gas used for dry etching, N₂, Ar, He, H₂ or a carrier gas that is a mixed gas thereof may be used. Furthermore, the molar ratio of the etching gas to the carrier gas is desired to be more than 0 and not more than 2.0. By using a carrier gas having such composition and molar ratio, the above-mentioned etching gas is diffused uniformly and the smoothness of depression 20 can be improved. Furthermore, complicated factors affecting the shape such as concavity and convexity is extremely reduced so as to smooth the depression, thereby easily allowing a plurality of depressions 20 to be formed in substantially the same shape.

In a dry etching processing, an etching gas is infused into the inside of depression 20 from the upper side of resist mask 28, and filled therein for a predetermined time. Thereafter, the etching gas is sucked (removed) and recovered, and the etching gas is filled and recovered again. It is preferable that such an operation is repeated a plurality of times. Thus, an etching gas can be diffused uniformly. Then, slight concavity and convexity are provided on the inner wall of through-hole 21 repeatedly so as to form through-hole 21 substantially linearly. Therefore, the length of through-hole 21 can be designed with high degree of accuracy. At the same time, in the vicinity of opening through-hole 21, cell 25 enters the concavity and convexity, so that the adhesiveness between cell 25 and through-hole 21 is improved.

Furthermore, in this exemplary embodiment, depression 20 and through-hole 21 are formed sequentially by dry etching using one resist mask 28 as shown in FIG. 9. Therefore, the position of the opening of through-hole 21 can be determined accurately in the deepest portion of depression 20. Since cell 25 drops by gravity, it is easily trapped in the deepest portion of depression 20. Therefore, by setting the position of the opening of through-hole 21 to be the deepest portion of depression 20, the measurement accuracy of device 11 for measuring cellular potential can be improved. Furthermore, a plurality of pairs of depression 20 and through-hole 21 can be formed in substantially the same shape. Since variation of the measurement error due to variation of shapes between the pairs is reduced, the measurement accuracy is improved. Furthermore, as compared with the case where two kinds of the resist masks are used, manufacturing time can be omitted, thus contributing to the reduction of the cost.

In this exemplary embodiment, depression 20 has an inner wall smoothly curving and standing from the opening of through-hole 21 to the upper side of the outer periphery. Cell 25 can fall down along this inner wall smoothly toward through-hole 21 by gravity. Therefore, cell 25 can be captured by depression 20 appropriately. The adhesiveness between cell 25 and through-hole 21 is enhanced, thus contributing the improvement of the measurement accuracy of device 11 for measuring cellular potential.

### Second Exemplary Embodiment

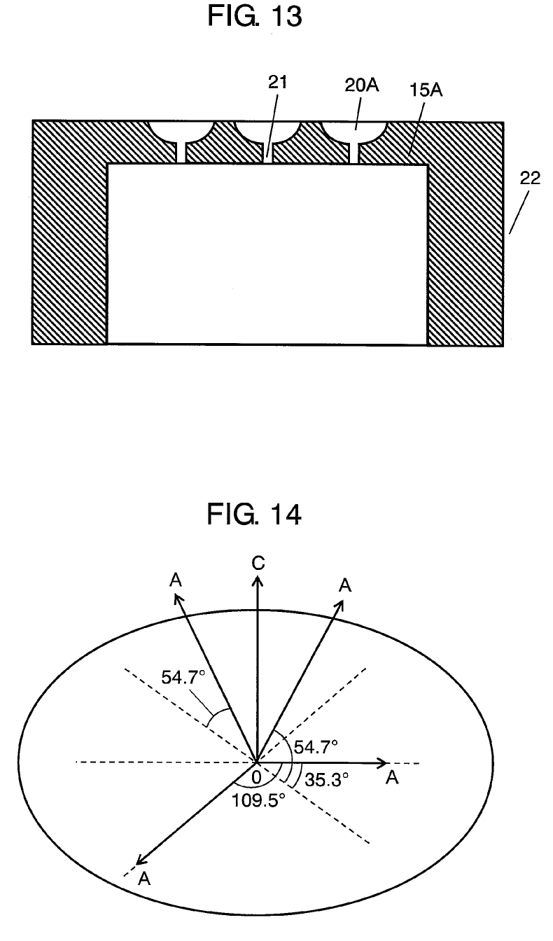

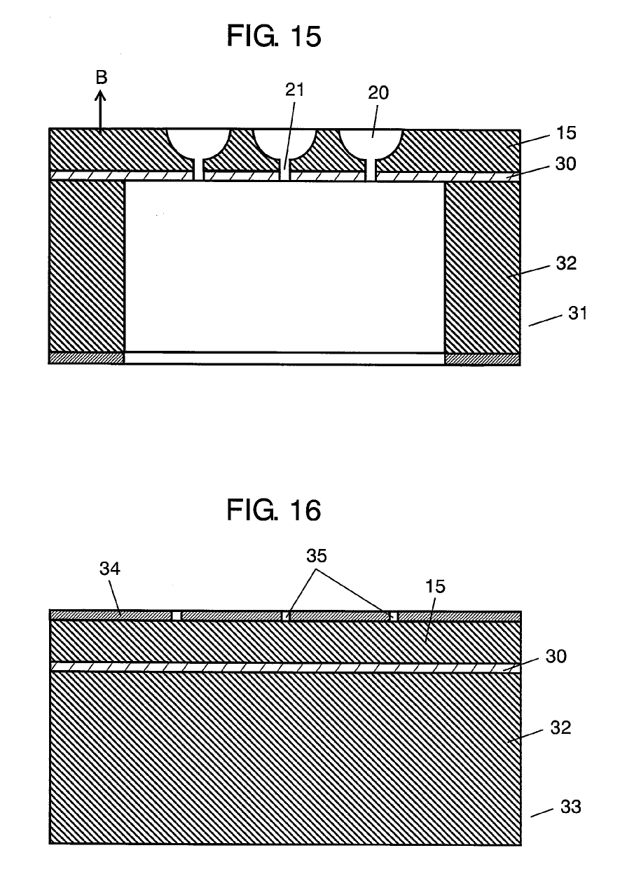

FIG. 12 and FIG. 13 are a perspective view and a sectional view showing a chip in a device for measuring cellular potential in accordance with a second exemplary embodiment of the present invention, respectively. FIG. 14 is a schematic view showing the positions of the (111) plane orientation in a single crystal silicon plate with (110) plane orientation, which is a substrate of the device for measuring cellular potential in accordance with this exemplary embodiment. This exemplary embodiment is the same as the first exemplary embodiment except that a single crystal silicon with (110) plane orientation is used as a material for substrate 15A in this exemplary embodiment. The (110) plane orientation includes (011) plane orientation and (101) plane orientation which are equivalent by symmetry of the crystalline structure.

As shown in FIG. 14, substrate 15A of a single crystal silicon plate with (110) plane orientation has (111) plane orientation at 90° and 35.3° with respect to the surface. That is to say, vector A is a normal vector of (111) plane orientation in (110) plane orientation and declines at 90° or 54.7° from the center O of substrate 15A. Furthermore, vector C is a normal vector of (110) plane orientation and the dotted lines show reference lines on substrate 15A.

In this exemplary embodiment, unlike the first exemplary embodiment, the shape of depression 20A is substantially semi-elliptical sphere. This is because normal vectors A of (111) plane orientation are not disposed equally in a concentric hemispherical shape from center O as shown in FIG. 14, the etching shape on the surface of substrate 15A becomes a substantially elliptical shape.

Thus, in this exemplary embodiment, as substrate 15A, a single crystal silicon plate with (110) plane orientation is used. Also in this case, the surface roughness of the inner wall of depression 20A is reduced and depression 20A has a smooth shape. Therefore, depression 20A has a shape that is excellent in symmetry with respect to the opening of through-hole 21 as a center. Therefore, if the relation between the opening diameter and depth of depression 20A is calculated for each etching condition, the depth of depression 20A can be calculated from the opening diameter of depression 20A that can be calculated from the appearance, when the etching condition is the same. As a result, the length of through-hole 21 can be designed with high degree of accuracy.

In this exemplary embodiment, unlike the first exemplary embodiment, only one free binding member of silicon atom exists on the surface of the (110) substrate, however, two binding members are present in parallel on the surface of substrate 15A. Therefore, the binding members are in the state in which they are easily reacted with each other. Therefore, when silicon substrate 15A with (110) plane orientation is used, similar to the case where silicon substrate 15 with (100) plane orientation is used, the etching in the direction of normal vector C of (110) plane orientation becomes faster. Then, it is possible to suppress the remarkable increase in the etching speed of silicon atoms in the horizontal direction. Furthermore, normal vectors A are disposed not in a hemispherical shape, but in a radial shape with symmetry. Therefore, it is estimated that the etching proceeds left-right symmetrically with respect to normal vector C.

As mentioned above, also in this exemplary embodiment, the surface roughness of the inner wall of depression 20A is reduced and depression 20A has a smooth shape. Therefore, the adhesiveness between through-hole 21 and cell 25 is enhanced and the measurement accuracy of device 11 for measuring cellular potential is improved.

Furthermore, in this exemplary embodiment, the shape of depression 20A becomes substantially semi-elliptical sphere. Therefore, when cell 25 having an elliptical spherical shape is intended to be measured, cell 25 can be stably held in depression 20A, thus contributing to the improvement of the measurement accuracy.

### Third Exemplary Embodiment

FIG. 15 is a sectional view showing a chip in a device for measuring cellular potential in accordance with a third exemplary embodiment of the present invention. The third exemplary embodiment is different from the first exemplary embodiment in that silicon oxide layer 30 is formed on a lower surface (second surface) of substrate 15. In other words, chip 31 of this exemplary embodiment has substrate 15 having a thickness of about 20 μm, silicon oxide layer 30 having a thickness of about 2 μm, and lower silicon layer 32 having a thickness of about 400 to 500 μm. Silicon oxide layer 30 is disposed on the lower surface of substrate 15. Lower silicon layer 32 is formed on the lower surface of silicon oxide layer 30 and forms a side wall standing from the lower surface of substrate 15. Substrate 15 is made of a single crystal silicon plate with (100) plane orientation. The other configurations are the same as those in the first exemplary embodiment. Note here that vector B shown in FIG. 15 shows a normal vector of (100) plane orientation.

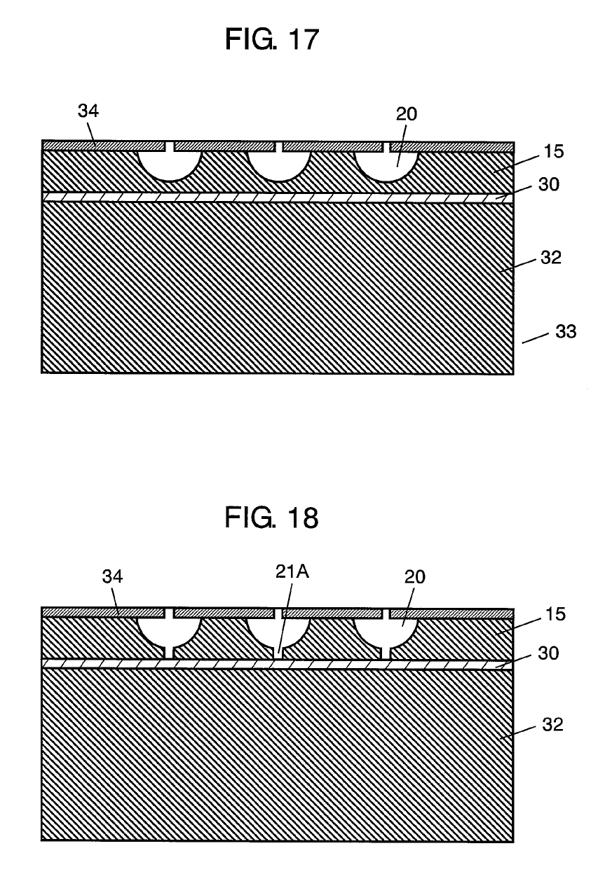

Next, a method of manufacturing chip 31 is described with reference to FIGS. 16 to 21. FIGS. 16 to 21 are sectional views showing steps of manufacturing the chip shown in FIG. 15.

Firstly, as shown in FIG. 16, on the upper surface of substrate 15 of chip substrate 33, resist mask 34 is formed. Chip substrate 33 is formed of three layers, i.e., substrate 15, silicon oxide layer 30 and lower silicon layer 32. Substrate 15 is made of a single crystal silicon plate having a thickness of about 20 μm and having (100) plane orientation. Silicon oxide layer 30 having a thickness of about 2 μm is disposed on the lower surface of substrate 15. Lower silicon layer 32 having a thickness of about 400 to 500 μm is disposed on the lower surface of silicon oxide layer 30.

Mask hole 35 of resist mask 34 is designed so that the shape of mask hole 35 is substantially the same shape of through-hole 21 of FIG. 15. In this exemplary embodiment, since the minimum opening diameter of through-hole 21 is 3 μm, the opening diameter of mask hole 35 is also 3 μm.

Thereafter, as shown in FIG. 17, dry etching is carried out from the upper surface of substrate 15 by using an etching gas selected from at least any one of SF₆, CF₄, NF₃, and XeF₂, and thus depression 20 is formed. The method of forming depression 20 is the same as that shown in the first exemplary embodiment.

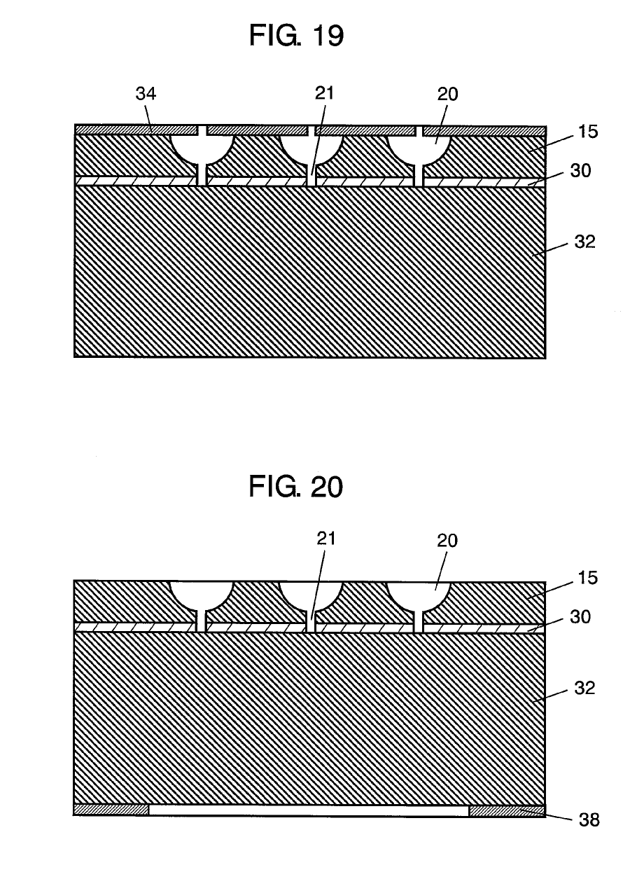

Next, as shown in FIG. 18, dry etching is carried out from depression 20 to the lower surface of substrate 15 so as to form hole 21A that is to be through-hole 21. At this time, when SF₆ for promoting etching of silicon is used as the dry etching gas, by the difference in the etching rate, silicon oxide layer 30 becomes an etching stop layer. That is to say, silicon oxide layer 30 is an etching stop layer having a smaller etching rate than that of a material constituting substrate 15. Then, it is possible to form the length of hole 21A constantly as designed. Thus, hole 21A can be formed by a simple method with high degree of accuracy.

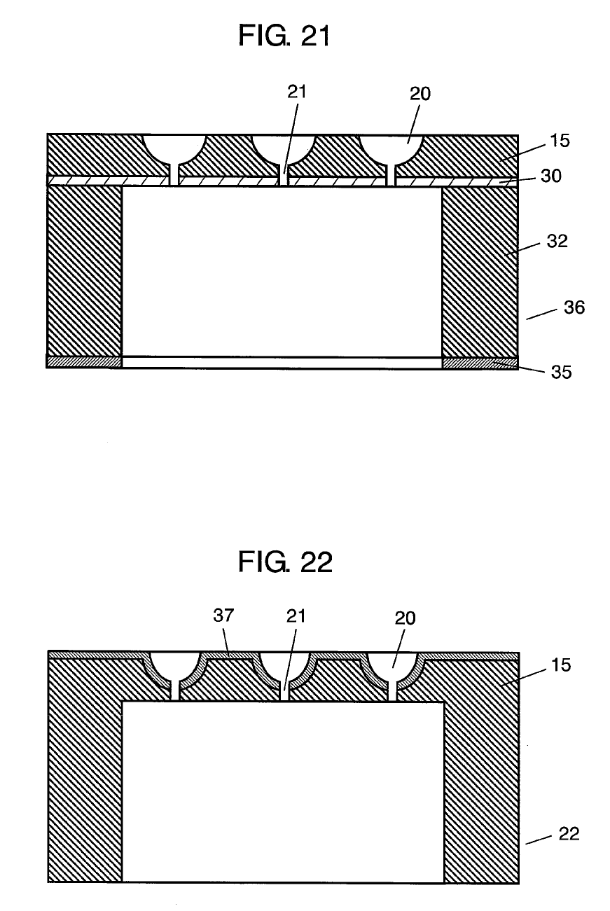

Next, as shown in FIG. 19, silicon oxide layer 30 is etched from the upper surface of substrate 15 by using a gas such as CF₄. Thus, through-hole 21 is formed. Thereafter, resist mask 34 is removed. Then, as shown in FIG. 20, on the lower surface of lower silicon layer 32, resist mask 38 is formed. Thereafter, as shown in FIG. 21, etching is carried out from the lower surface of lower silicon layer 32 to silicon oxide layer 30 so as to complete through-hole 21. At this time, since silicon oxide layer 30 works as an etching stop layer, the thickness of substrate 15 can be adjusted with high degree of accuracy. As a result, the length of through-hole 21 can be made with high degree of accuracy. The other effects are the same as those in the first exemplary embodiment, so that the description thereof is omitted herein.

Note here that for substrate 15, a single crystal silicon layer with (100) plane orientation is used. However, even if a single crystal silicon layer with (110) plane orientation is used, the surface roughness of depression 20 can be reduced and the surface shape can be smoothed. Furthermore, the shape of the inner wall can be made to be a shape that is free from the level difference and excellent in symmetry. Furthermore, when the surface has less concavity and convexity, the factors affecting the shape are reduced. Therefore, when a plurality of depressions 20 is formed, the uniformity of the shapes thereof can be enhanced. That is to say, the same effect of the second exemplary embodiment can be obtained.

Furthermore, in this exemplary embodiment, when substrate 15 is made of silicon, silicon oxide layer 30 is used as the etching stop layer. However, besides, the etching stop layer may be formed of silicon nitride (Si₃N₄).

### Fourth Exemplary Embodiment

FIG. 22 is a sectional view showing a chip in a device for measuring cellular potential in accordance with a fourth exemplary embodiment of the present invention. This exemplary embodiment is different from the first exemplary embodiment in that the upper surface of substrate 15 and the inner wall of depression 20 are covered with silicon oxide film 37. That is to say, at least the surface of depression 20 is provided with film 37 of an insulating material. The other configurations are the same as those of the first exemplary embodiment.

Thus, the surface roughness of the inner wall of depression 20 is reduced and the inner wall is smoothed. Therefore, cell 25 is easily brought into close contact with the opening of through-hole 21 and the measurement accuracy of device 11 for measuring cellular potential is improved. Furthermore, by using an insulating material as a material of film 37, the insulating property of the upper part and lower part of through-hole 21 is enhanced, thus contributing to the improvement of reliability of the measurement accuracy.

As materials of film 37, silicon nitride, silicon oxynitride, or the mixture thereof can be used besides silicon oxide. For example, film 37 made of silicon oxide or silicon nitride can be formed by sputtering silicon oxide or silicon nitride. With such a method, film 37 is not easily formed on the inner wall of through-hole 21 having a large aspect ratio. Film 37 is formed only on the upper surface of substrate 15 and on the inner wall of depression 20. Furthermore, when chip 22 made of silicon is thermally treated under oxygen atmosphere, silicon oxide film 37 is formed on the entire surface of chip 22. Thus, as film 37, film 37 made of an insulating material may be provided on at least the surface of depression 20.

When silicon oxide is used as film 37, as compared with the case where film 37 is not used for covering, the hydrophilic property of the inner wall of depression 20 is improved. In general, since the surface of cell 25 has a hydrophilic property, when the hydrophilic property of the inner wall of depression 20 is improved, cell 25 is brought into close contact with and held by the inner wall of depression 20. Specifically, when film 37 is provided, as compared with the case where film 37 is not provided, the contact angle of cell 25 and the surface of depression 20 is reduced to about ⅓. The other effects are the same as those of the first exemplary embodiment, so that the description is omitted.

### Fifth Exemplary Embodiment

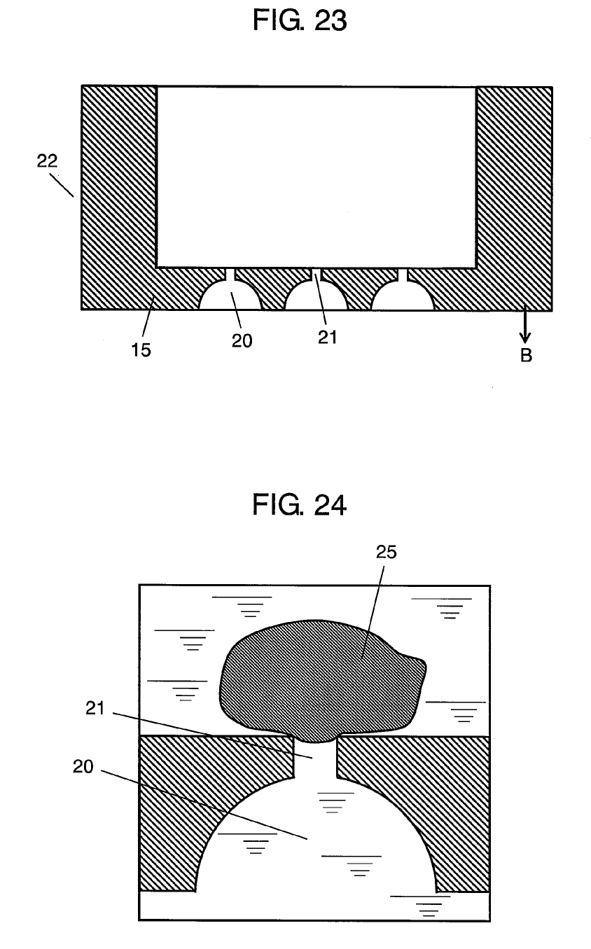

FIG. 23 is a sectional view showing a chip in a device for measuring cellular potential in accordance with a fifth exemplary embodiment of the present invention. FIG. 24 is an enlarged sectional view of the chip shown in FIG. 23. This exemplary embodiment is different from the first exemplary embodiment in that chip 22 is inverted upside down and disposed on chip plate 13 shown in FIG. 1.

That is to say, in this exemplary embodiment, substrate 15 is a silicone plate with (100) plane orientation. On the upper surface (second surface) of substrate 15, through-hole 21 is formed, and on the lower surface (first surface), depression 20 is formed. Depression 20 has an inner wall having a substantially hemispherical shape, extending from the opening of through-hole 21 to the outer periphery, smoothly curving and connected to the upper surface.

Thus, in this exemplary embodiment, the variation of the length of through-hole 21 is reduced. Moreover, the change of the sectional area of the flow passage from through-hole 21 to second electrode tank 18 shown in FIG. 1 becomes gentle. The flow resistance is reduced, and electrolyte or the like easily flows. Furthermore, sucking from the lower part of substrate 15 is easily carried out. Therefore, cell 25 can be brought into close contact with the opening of the through-hole 21. Furthermore, liquid medicine such as nystatin that is infused from the lower part of substrate 15 can easily flow into through-hole 21 and can rapidly reach cell 25.

Furthermore, since the inner wall surface of depression 20 is smooth, bubbles generated on the inner wall of depression 20 are reduced. Therefore, it is possible to suppress the difficulty, due to the presence of bubbles, in transmitting the pressure when cell 25 is sucked into through-hole 21. Therefore, cell 25 can be appropriately brought into close contact with through-hole 21.

Still further, it is preferable that the surface roughness of through-hole 21 is made to be larger than the surface roughness of depression 20. Thus, the concavity and convexity on the inner wall of through-hole 21 work as an anchor with respect to cell 25. Even when depression 20 is not formed on the upper surface of substrate 15, the adhesiveness with respect to through-hole 21 can be further improved and the measurement accuracy can be enhanced. Besides, the description of the same configuration and effects as those in the first exemplary embodiment is omitted.

Note here that in this exemplary embodiment, as substrate 15, a silicon plate with (100) plane orientation is used. However, when a silicon plate with (110) plane orientation is used as substrate 15 similar to the second exemplary embodiment, the same effect can be obtained. Furthermore, the inner wall of depression 20 or the lower surface of substrate 15 may be covered with insulating film 37 made of silicon oxide and the like, similar to the fourth exemplary embodiment. Thus, the inner wall of depression 20 is further smoothed and electric insulating property of the upper part and lower part of through-hole 21 is enhanced.

### Sixth Exemplary Embodiment

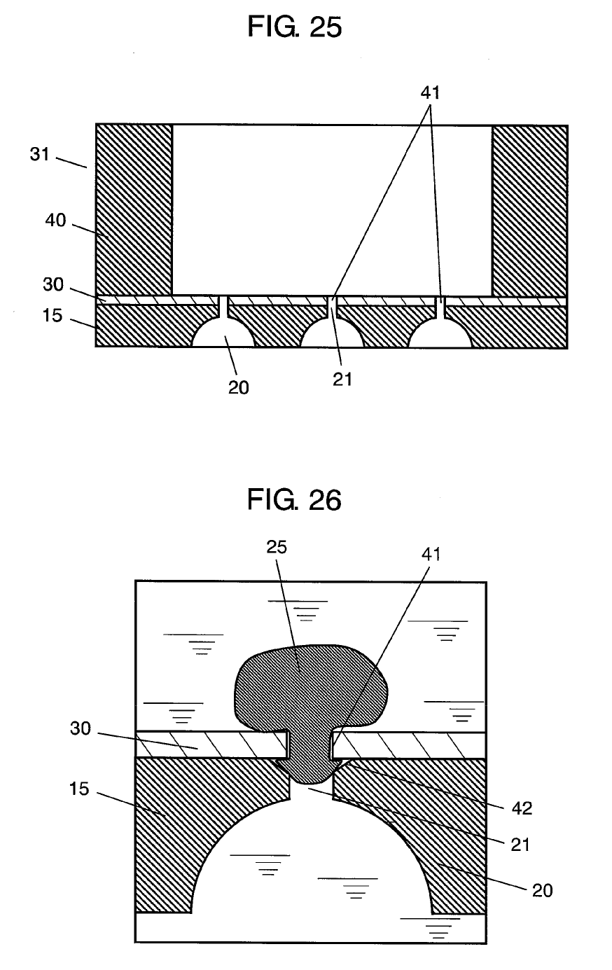

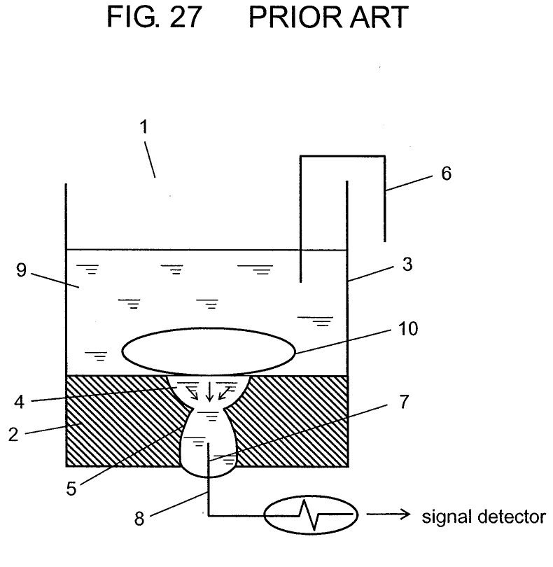

FIG. 25 is a sectional view showing a chip in a device for measuring cellular potential in accordance with a sixth exemplary embodiment of the present invention. FIG. 26 is an enlarged sectional view of the chip shown in FIG. 25. This exemplary embodiment is different from the third exemplary embodiment in that chip 31 is inverted upside down and disposed on chip plate 13 of FIG. 1 and that silicon oxide layer 30 is formed on the upper surface (second surface) of substrate 15.

In other words, chip 31 has substrate 15 having a thickness of about 20 μm, silicon oxide layer 30 having a thickness of about 2 μm, and upper silicon layer 40 having a thickness of about 400 to 500 μm. Silicon oxide layer 30 is disposed on the upper surface of substrate 15. Upper silicon layer 40 is formed on silicon oxide layer 30. Thus, this exemplary embodiment has a configuration combining the third exemplary embodiment and the fifth exemplary embodiment.

Also in this configuration, similar to the third exemplary embodiment, silicon oxide layer 30 becomes an etching stop layer and the thickness of substrate 15 can be designed with high degree of accuracy. Furthermore, the depth of depression 20 can be designed with high degree of accuracy similar to the first exemplary embodiment. As a result, the controlling accuracy of the length of through-hole 21 is improved. In addition, the same effect as that of the fifth exemplary embodiment can be obtained.

Furthermore, in this exemplary embodiment, through-hole 21 is formed in substrate 15 from depression 20 to silicon oxide layer 30, then hole 41 is formed in silicon oxide layer 30. Therefore, an etching gas (for example, SF₅⁺) for forming through-hole 21 in substrate 15 stops on silicon oxide layer 30 and plus ions of this etching gas are repulsing and dispersing in the lateral direction of through-hole 21. Thus, the etching is allowed to proceed in the lateral direction intentionally.

As a result, as shown in FIG. 26, on the contact surface between substrate 15 and silicon oxide layer 30, the opening diameter of through-hole 21 becomes larger than that of hole 41 of silicon oxide layer 30, so that dent 42 is provided on the inner wall of through-hole 21. Cell 25 that is in close contact with the opening of hole 41 is trapped by dent 42. Thus, adhesiveness between opening of hole 41 and cell 25 is improved. Also in this exemplary embodiment, silicon plate with (110) plane orientation may be used as substrate 15.

Furthermore, in the first to sixth exemplary embodiments, as substrate 15, a silicon plate is used. However, besides, a single crystal plate having a diamond structure, for example, diamond may be used. In the case of using a diamond, as an etching gas, oxygen and the like can be used. Furthermore, chips 22 and 31 have side wall 22A standing from the lower surface of substrate 15 or lower silicon layer 32. However, only substrate 15 may be fixed to the opening of chip plate 13.

### INDUSTRIAL APPLICABILITY

In a substrate and a method of manufacturing the same in accordance with the present invention, it is possible to control the length of the through-hole and equalize the lengths of the through holes with high degree of accuracy. Furthermore, the surface shape of the inner wall of the depression provided on the substrate and holding cells is smoothed. Thus, the measurement accuracy of the device for measuring cellular potential using this substrate can be improved. Thus, in the medical and biotechnological fields requiring highly accurate measurement, the device of the present invention is useful in a device in which a fine electronics mechanical system (MEMS) technology is applied.

1. A substrate for a device for measuring cellular potential, comprising:
a single crystal plate including a first surface and a second surface facing the first surface, and having a diamond structure with (100) plane orientation;
wherein the first surface is provided with a depression, a through-hole is formed from the depression to the second surface, and the depression has an inner wall extending from an opening of the through-hole to an outer periphery, curving and being connected to the first surface.

2. The substrate according to claim 1, wherein the depression has a hemispherical shape.

3. The substrate according to claim 1, wherein a diameter of the through-hole is more than 0 μm and not more than 3 μm.

4. The substrate according to claim 1, further comprising a film made of an insulating material disposed on a surface of the depression.

5. The substrate according to claim 1, wherein a surface roughness of an inner wall of the through-hole is larger than a surface roughness of the inner wall of the depression.

6. The substrate according to claim 1, further comprising an etching stop layer that is formed on the second surface of the substrate and has an etching rate smaller than an etching rate of a material constituting the substrate.

7. A device for measuring cellular potential, comprising:
a substrate for a device for measuring cellular potential according to claim 1,
a first electrode tank disposed on an upper side of the substrate;
a first electrode disposed inside the first electrode tank;
a second electrode tank disposed on a lower side of the substrate; and
a second electrode disposed inside the second electrode tank.

8. A substrate for a device for measuring cellular potential, comprising:
a single crystal plate including a first surface and a second surface facing the first surface, and having a diamond structure with (110) plane orientation;
wherein the first surface is provided with a depression, a through-hole is formed from the depression to the second surface, and the depression has an inner wall extending from an opening of the through-hole to an outer periphery, curving and being connected to the first surface.

9. The substrate according to claim 8, wherein the depression has a semi-elliptical sphere shape.

10. The substrate according to claim 8, wherein a diameter of the through-hole is more than 0 μm and not more than 3 μm.

11. The substrate according to claim 8, further comprising a film made of an insulating material disposed on a surface of the depression.

12. The substrate according to claim 8, wherein a surface roughness of an inner wall of the through-hole is larger than a surface roughness of the inner wall of the depression.

13. The substrate according to claim 8, further comprising an etching stop layer that is formed on the second surface of the substrate and has an etching rate smaller than an etching rate of a material constituting the substrate.

14. A device for measuring cellular potential, comprising:
a substrate for a device for measuring cellular potential according to claim 8,
a first electrode tank disposed on an upper side of the substrate;
a first electrode disposed inside the first electrode tank;
a second electrode tank disposed on a lower side of the substrate; and
a second electrode disposed inside the second electrode tank.

15. A method of manufacturing a substrate for a device for measuring cellular potential, the method comprising:
forming a resist mask having a mask hole on a first surface of a single crystal plate, the single crystal plate including the first surface and a second surface facing the first surface and having any one of a diamond structure with (100) plane orientation and a diamond structure with (110) plane orientation by using a photo mask;
forming a depression on the first surface by dry etching; and
providing a through-hole having a same diameter as that of the mask hole, the through-hole being allowed to penetrate the single crystal plate from the depression to the second surface by dry etching.

16. The method according to claim 15, wherein an opening diameter of the mask hole is more than 0 μm and not more than 3 μm.

17. The method according to claim 15, wherein in the forming of the depression, an etching gas is used, and the etching gas is at least one of CF₄, SF₆, NF₃ and XeF₂.

18. The method according to claim 15, wherein in the forming of the depression, an etching gas and a carrier gas are used, and the carrier gas is at least one of N₂, Ar, He and H₂.

19. The method according to claim 15, wherein in the forming of the depression, an etching gas and a carrier gas are used, and a molar ratio of the etching gas to the carrier gas is more than 0 and not more than 2.0.

20. The method according to claim 15, wherein in the forming of the depression, an etching gas is used, and filling and removing of the etching gas are repeated a plurality of times.

21. The method according to claim 15, wherein in the providing of the through-hole, an etching gas and an etching suppressing gas are used alternately.

22. The method according to claim 21, wherein the etching gas is at least one of CF₄, SF₆, NF₃ and XeF₂.

23. The method according to claim 21, wherein the etching suppressing gas is at least one of CHF₃ and C₄F₈.
